(19) United States
(12) Patent Application Publication
(10) Pub. No.: US 2025/0168463 A1
(43) Pub. Date: May 22, 2025

(54) System, Method, and Application for Television Program Reminders

(71) Applicant: Yvette Darlene Rogers, New Carrollton, MD (US)

(72) Inventor: Yvette Darlene Rogers, New Carrollton, MD (US)

(21) Appl. No.: 18/897,732

(22) Filed: Sep. 26, 2024

Related U.S. Application Data
(60) Provisional application No. 63/601,204, filed on Nov. 20, 2023.

(51) Int. Cl. H04N 21/488; H04N 21/258; H04N 21/262; H04N 21/462

(52) U.S. Cl. CPC H04N 21/4882; H04N 21/25891; H04N 21/26283; H04N 21/462

(57) ABSTRACT

A television program reminder system for displaying a reminder notification for one or more television programs is disclosed. The system provides a reminder notification application for providing a notification that includes time information and an audio announcement of the show title and the estimated start time thereof. The reminder notification can be simultaneously displayed on multiple devices, such as smartphones, smartwatches, and tablets along with a television, wherein the devices are registered using the application. In one embodiment, the application provides options to customize the notification including frequency, pattern, color, and more. In other embodiments, the system automatically switches to the channel on which the program for which the notification is generated to be aired.

### CROSS-REFERENCE TO RELATED APPLICATION

The present application claims priority to, and the benefit of, U.S. Provisional Application No. 63/601,244, which was filed on Nov. 21, 2023, and is incorporated herein by reference in its entirety.

### FIELD OF THE INVENTION

The present invention generally relates to the field of television programs. More specifically, the present invention relates to a novel television feature that reminds individuals when a program or show is about to air. The feature is offered by a system using an application and provides reminders on a television and other devices and can be set for weekly programs, notifying the user through the TV and other linked electronics that the show is about to start. The system includes multiple features for notifying the user about their programs, such as, video and voice commands, flashing colors and patterns, personalized banners, and more. Multiple reminder options are available to prevent individuals from missing a television program. Accordingly, the present disclosure makes specific reference thereto. Nonetheless, it is to be appreciated that aspects of the present invention are also equally applicable to other like applications, devices, and methods of manufacture.

### BACKGROUND

By way of background, television channels offer rich and varied programs ranging from weekly series to special live events. With the proliferation of channels and streaming options, users often find it difficult to keep track of the schedule of airing of their favorite shows. Special television events such as award shows, live sports events, televised concerts, or one-off specials, often happen outside the regular programming schedule. Such events are typically live and offer unique, interactive features that lose their immediacy and impact when not experienced live. For some content, especially premium or exclusive events, users have to pay extra to access a replay or recap. Being able to participate in live events, interact with other viewers in real-time, and engage in social media discussions enhances the overall viewing experience.

Missing a live airing can cause missing out on being part of a shared cultural moment, live voting, real-time commentary, and social media integration or having to avoid spoilers. Conventional reminders such as those set by users in their smartphones are ineffective and can mix up with other reminders. Also, such reminders are static and cannot automatically adjust based on changes in the program schedule. Individuals desire an effective reminder system dedicated to preventing viewers from missing their favorite television programs and special events, which can be integrated with both live TV and streaming channels.

Therefore, there exists a long-felt need in the art for an improved reminder system that can provide notifications to users for their favorite shows and special events. There is also a long-felt need in the art for a reminder notification system that can work across live television and various streaming platforms for providing reminders to users based on their subscriptions and preferences. Additionally, there is a long-felt need in the art for a novel reminder system for television programs that automatically adjusts reminders based on changes in the program schedule. Moreover, there is a long-felt need in the art for a software application that enables users to select programs for scheduled reminders. Further, there is a long-felt need in the art for a system that mitigates frustration and potential additional costs associated with missing live airings. Furthermore, there is a long-felt need in the art for a program reminder application that provides customizable, timely reminders for one or more programs across a range of devices and integrates with both live and streaming platforms. Finally, there is a long-felt need in the art for a reminder notification that prevents individuals from accidentally missing their favorite weekly television programs and helps in enhancing the television viewing experience.

The subject matter disclosed and claimed herein, in one embodiment thereof, comprises a television program reminder notification system. The system comprises a notification server configured to send reminders to at least one user device regarding upcoming television programs, an electronic program guide (EPG) server in communication with the notification server, the EPG server containing details of television programs available to users, facilitating the selection of programs for which reminders are to be set, at least one client device configured to display the reminder notifications for the at least one upcoming program, a program reminder notification application for enabling users to set and customize reminders for the one or more television programs, wherein the customization includes frequency and personalization of reminders, and wherein the reminder notification is displayed as a pop-up on the client device. The system automatically switches to the channel on which the program is to be aired, wherein the switching is performed while displaying the reminder notification.

In this manner, the television program reminder system and associated application of the present invention accomplish all of the foregoing objectives and provide users with a software application designed to help users keep track of when their favorite TV programs, series, sporting events, or movies are scheduled to air. The system enables users to set reminders for specific TV shows, movies, events, or series and includes the ability to automatically switch to the correct channel when a program is about to start, making the viewing experience seamless. The system provides reminders on multiple devices, including televisions, smartphones, tablets, and computers, so users can be alerted regardless of their current activity or location.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for displaying a reminder notification for a television program. The method comprises the steps of presenting, via a display of a television, a list of television programs; receiving, via the display, selection of at least one program; receiving input associated with the selected at least one program, wherein the input includes at least a frequency of a reminder and pattern of the reminder, wherein the reminder is displayed in the form of a notification on the display of the television at a predetermined time before airing of the program. The reminder notification prevents a user from accidentally missing the program.

In another aspect, a tangible, non-transitory computer-readable medium having instructions stored thereon that when executed by a processor is disclosed. The processor performs the method, the method comprises displaying, via a display of a television, a list of television programs; receiving, via the display, selection of at least one program; receiving input associated with the selected at least one program, wherein the input includes at least a frequency of a reminder, a pattern of the reminder and a list of devices, wherein the reminder is displayed in the form of a notification on the display of the television and on the list of devices at a predetermined time before airing of the program.

In another embodiment, a television program reminder notification system is disclosed. The system comprises a notification server configured to send reminders to at least one user device regarding upcoming television programs, an electronic program guide (EPG) server in communication with the notification server, the EPG server containing details of television programs available to users, facilitating the selection of programs for which reminders are to be set, at least one client device configured to display the reminder notifications for the at least one upcoming program, a program reminder notification application for enabling users to set and customize reminders for the one or more television programs, wherein the customization includes frequency and personalization of reminders, and wherein the reminder notification is displayed as a pop-up on the client device.

In another embodiment of the present invention, the system includes a cloud storage adapted to store user preferences, program schedules, and reminder settings, as well as user details, enabling the notification server to suggest reminders for programs based on previous watch history or indicated interests of users.

In yet another embodiment, the system and the application provide notifications for weekly programs, specials, or sporting events such as the Super Bowl and the Olympics.

In a further embodiment, a method for setting reminders for television programs is described. The method includes the steps of receiving, via a reminder application, selections of one or more television programs; receiving, settings for the frequency of the reminder notification for the selected programs; receiving, customization preferences including appearance, pattern, and color of notification; and receiving, information regarding one or more additional devices to receive the reminder notification for the selected programs, wherein information of additional devices is stored in a cloud storage and used by a notification server for displaying the reminder notifications on the additional devices.

In yet another embodiment, the method includes the step of automatic switching to the channel on which the program is to be aired, wherein the switching is performed while displaying the reminder notification.

In one aspect, the reminder notification includes time information indicating an estimated start time of a scheduled program and an audio message that includes the title of the show or program and the estimated time until the start of the program.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of the television program reminder system of the present invention in accordance with the disclosed architecture;

FIG. 2 illustrates a flow chart depicting a process of setting a television program reminder using the television program reminder system of the present invention in accordance with the disclosed architecture;

FIG. 3 illustrates a perspective view showing an exemplary reminder notification displayed on the television of a user in accordance with one embodiment of the present invention;

FIG. 4 illustrates a perspective view showing the reminder notification being displayed or notified in multiple devices simultaneously in accordance with one embodiment of the present invention;

FIG. 5 illustrates an exemplary user interface offered by the reminder notification application for setting the reminder notifications for programs in accordance with one embodiment of the present invention;

FIG. 6 illustrates an exemplary EPG adapted to enable users to set reminders for at least one program in accordance with one embodiment of the present invention; and

FIG. 7 illustrates a block diagram depicting essential hardware components of an exemplary television used for installing notification applications in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved reminder system that can provide notifications to users about their favorite shows and special events. There is also a long-felt need in the art for a reminder notification system that can work across live television and various streaming platforms for providing reminders to users based on their subscriptions and preferences. Additionally, there is a long-felt need in the art for a novel reminder system for television programs that automatically adjusts reminders based on changes in the program schedule. Moreover, there is a long-felt need in the art for a software application that enables users to select programs for scheduled reminders. Further, there is a long-felt need in the art for a system that mitigates frustration and potential additional costs associated with missing live airings. Furthermore, there is a long-felt need in the art for a program reminder application that provides customizable, timely reminders for one or more programs across a range of devices and integrates with both live and streaming platforms. Finally, there is a long-felt need in the art for a reminder notification that prevents individuals from accidentally missing their favorite weekly television programs and helps in enhancing the television viewing experience.

The present invention, in one exemplary embodiment, is a method for displaying a reminder notification for a television program. The method comprises the steps of presenting, via a display of a television, a list of television programs; receiving, via the display, selection of at least one program; receiving input associated with the selected at least one program, wherein the input includes at least a frequency of a reminder and pattern of the reminder, wherein the reminder is displayed in the form of a notification on the display of the television at a predetermined time before airing of the program. The reminder notification prevents a user from accidentally missing the program.

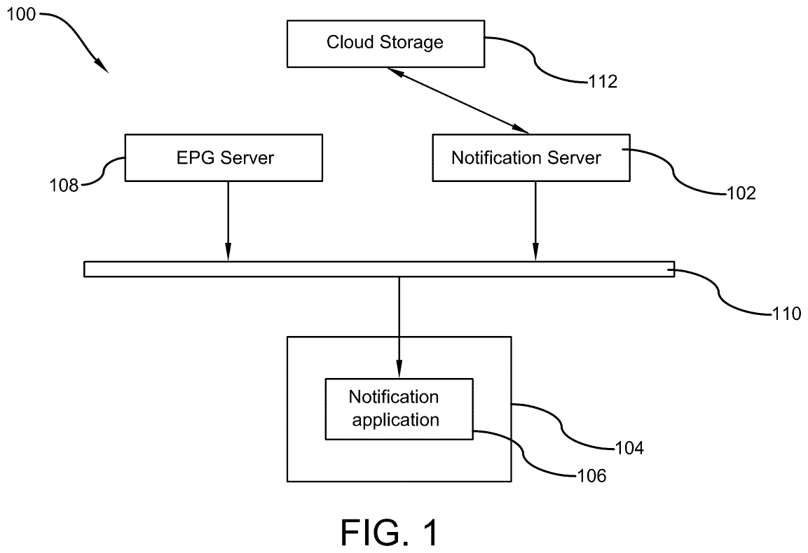

Referring initially to the drawings, FIG. 1 illustrates a schematic diagram of the television program reminder system of the present invention in accordance with the disclosed architecture. The television program reminder system 100 of the present invention is designed to provide a television application or feature to remind users of an upcoming show such as specific TV shows, movies, series, and more. The television program reminder notification system 100 also gives the ability to a user to customize the frequency of the reminder and personalize the reminder tailored to enhance the viewing experience of users. More specifically, the reminder system 100 includes a notification server 102 for sending reminders to at least one user for a program such as a weekly program, sporting event, Super Bowl, Olympics, and more indicating that the program is about to start. The notification server 102 can work in conjunction with an electronic program guide (EPG) server 104 which includes the details of different programs offered to the users. The reminder notification transmitted by the notification server 102 is displayed on at least one client device 104 which can include television, smartphone, wearable device (i.e., smartwatch), and more.

The notification server 102 provides a program reminder notification application 106 using which a user can set and customize a reminder for one or more programs. The reminder notification for a program is also displayed by reminder notification application 106 in the form of a pop-up. The notification application 106 can display programs from the EPG provided by the EPG server 108 for setting the notification. The notification application 106 is adapted to run on the operating system of a television or on an external device like a set-top box. In some embodiments, the reminder notification application 106 is a standalone application which couples with the EPG. The application 106 can also integrate with the channel control system of the device 104 to enable automatic switching to the channel of the program at the reminder time.

The reminder server can couple with the client device 104 over a broadcast channel 110 which can be a satellite channel or an IP channel depending on the implementation of the television broadcasting system. A cloud storage 112 is adapted to store user preferences, program schedules, and reminder settings. The cloud storage 112 also stores the details of the users and the notification server 102 can suggest reminders for programs similar to those the users have watched previously or shown interest in.

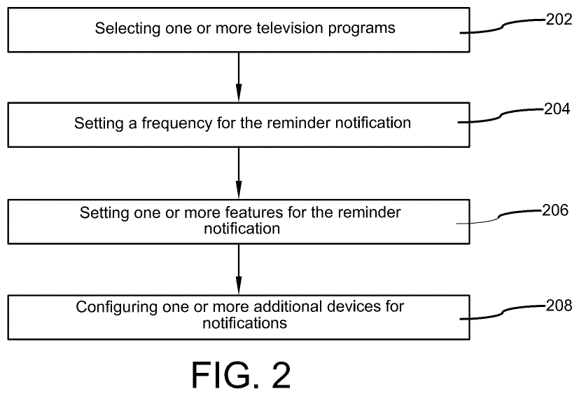

FIG. 2 illustrates a flow chart depicting a process of setting a television program reminder using the television program reminder system of the present invention in accordance with the disclosed architecture. Initially, a user adds/selects one or more television programs or events to the reminder application 106 offered by the system 100 (Step 202). In some embodiments, the user can select a program in the reminder application and alternatively, one or more programs can be selected in the EPG for setting the reminder notification wherein the EPG and the notification application 106 are coupled to each other.

Then, in the next step, a frequency for the reminder notification for a program is set by the user (Step 204). The frequency of the reminder notification can be exemplary set as daily, weekly, and more before the airing of the program. The feature can also include setting reminders at different intervals such as 30 minutes, 15 minutes, and 5 minutes before the program starts. Thereafter, one or more features for the reminder notification is set by the user (Step 206) wherein the features can include appearance, pattern, and color of the notification. The configured features are set for the notifications displayed on different devices. Finally, the user can add one or more additional devices such as a smartphone (by providing a cellular number), an email ID, or a device nearby the television for receiving the reminder notification of at least one program (Step 208). The details of the additional devices are stored in the cloud storage 112 and is used by the notification server 102 for sending reminder notifications.

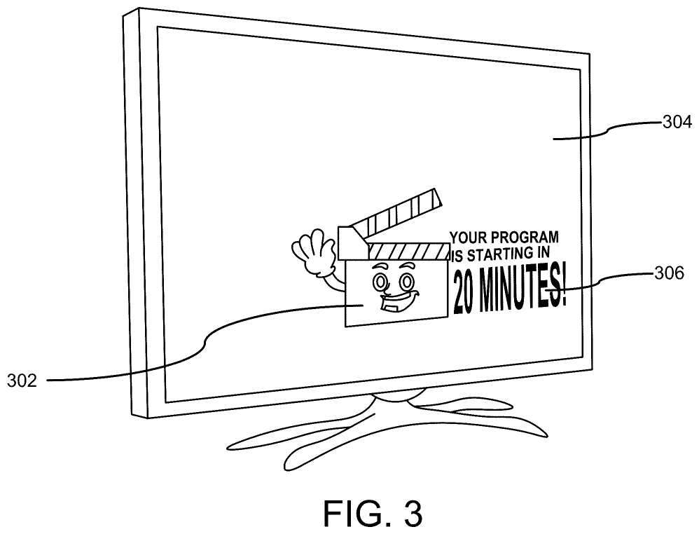

FIG. 3 illustrates a perspective view showing an exemplary reminder notification displayed on the television of a user in accordance with one embodiment of the present invention. In the present embodiment, the reminder notification 302 is displayed on the television 304 and includes time information 306 such as an estimated time in starting of the scheduled program. The notification 302 may also play an audio including the show/program title and estimated time in starting of the program.

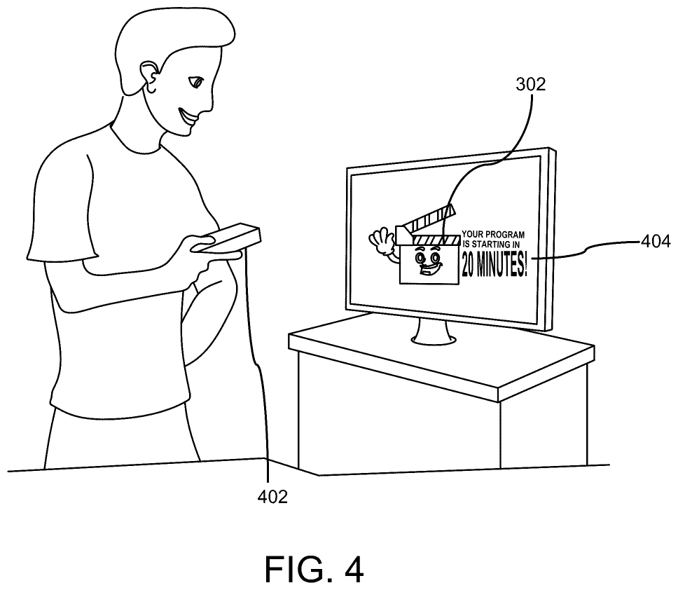

FIG. 4 illustrates a perspective view showing the reminder notification being displayed or notified in multiple devices simultaneously in accordance with one embodiment of the present invention. In one embodiment of the present invention, the reminder notification 302 can be displayed on multiple devices 402, 404 simultaneously. The devices 402, 404 can be included for receiving notifications in the reminder application 106 and the reminder notification server 102 sends the notification as per the configured schedule.

In some embodiments, the notification application 106 has access to the channel control system (not shown) of the device 402 and can automatically switch to the channel when the notification is transmitted and displayed.

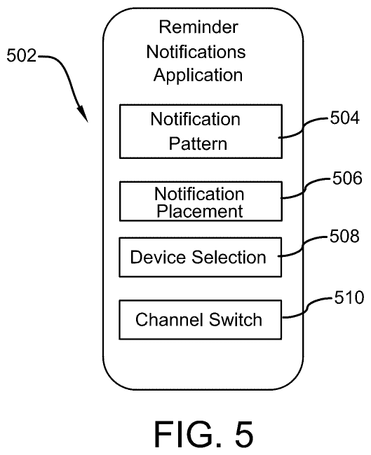

FIG. 5 illustrates an exemplary user interface offered by the reminder notification application for setting the reminder notifications for programs in accordance with one embodiment of the present invention. In the user interface 502, a notification pattern option 504 enables a user to configure a pattern of the reminder notification. The notification pattern can be one of flashing color, a waving emoji, a personalized character, and more. A notification placement option 506 enables a user to select a specific position of the reminder notification such as at the center of the screen or a full display notification. The notification is automatically adjusted based on the display size and aspect ratio of the device by the notification server 102 using the specifications of the devices stored in the cloud storage 112. A device selection option 508 provides the ability to a user to select one or more devices from the list of personal devices for receiving notification of a scheduled program. A channel switch option 510 provides a Yes/No option for enabling auto-switching to a channel on which the program for which the notification is generated is to be aired. Closed captions can also be separately scheduled by users using the notification application 106.

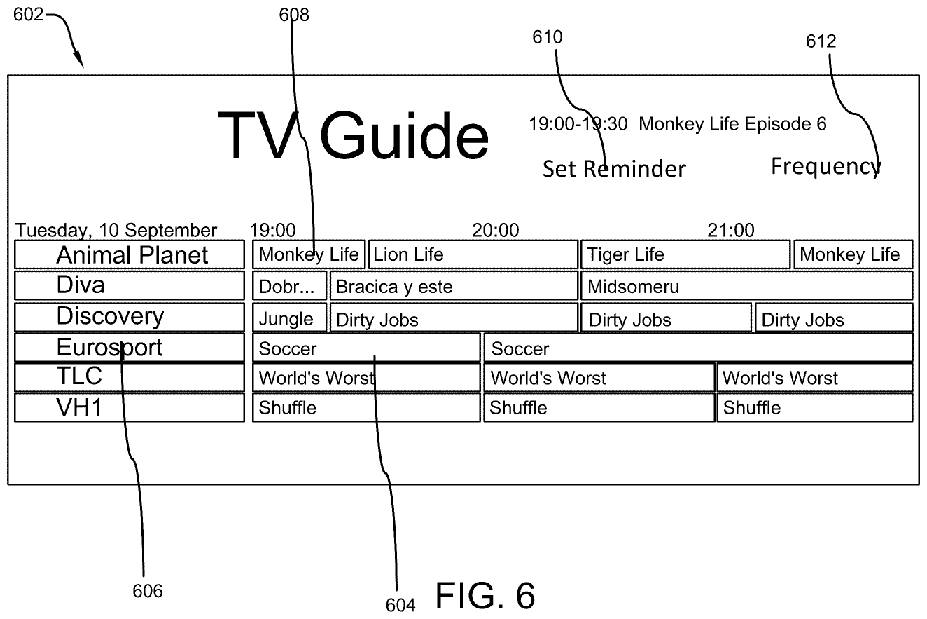

FIG. 6 illustrates an exemplary EPG adapted to enable users to set reminders for at least one program in accordance with one embodiment of the present invention. As illustrated, in the present embodiment, the EPG 602 displays a plurality of programs 604 offered by a plurality of channels 606. On selection of a program (shown through numeral 608), a “Set Reminder” option 610 and a “Frequency” option 612 are displayed. The Set Reminder option 610 enables a user to set a reminder for the selected program and using the interface 502, other parameters can be set for the reminder notification. A frequency and a timing of the reminder notification can be set using the “Frequency” option 612.

It should be noted that in other embodiments of the present invention, the notification application 106 can enable a user to select a program and set reminders along with the frequency set in FIG. 6 of the present disclosure.

In some embodiments, the application 106 can be in the form of an integrated feature or an update in the set-top box or digital video recorder. The interface of a device connected to the set-top box can display different options for setting reminders for programs.

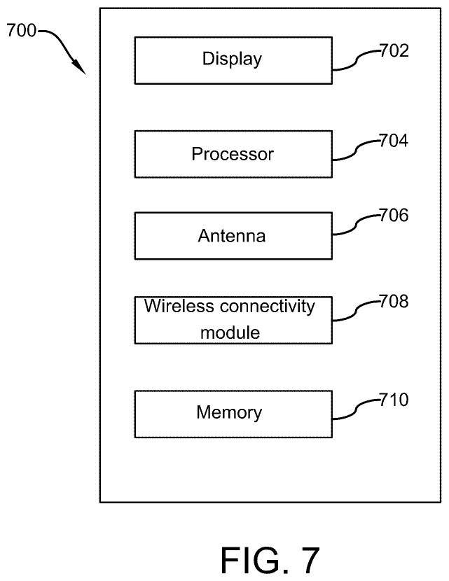

FIG. 7 illustrates a block diagram depicting essential hardware components of an exemplary television used for installing notification applications in accordance with one embodiment of the present invention. The television 700 includes a display 702 which can be full color display and may be touch sensitive. The touch sensitive display 702 is capable of providing visual output to a user, and a capacitive input matrix of the touch sensitive screen 702 can receive input from the user.

A processor 704 generally functions to run programming code or instructions implementing various functions including the reminder notification application 106 of the television 700. The processor 704 can comprise a general-purpose programmable processor or controller for executing application programming or instructions. In accordance with at least some embodiments, the processor 704 may include multiple processor cores, and/or implement multiple virtual processors. In accordance with still other embodiments, the processor 704 may include multiple physical processors.

The television 700 also includes at least one antenna 706 and a wireless connectivity module 708. As examples, the wireless connectivity module 706 can comprise a GSM, CDMA, FDMA, and/or analog cellular telephony transceiver capable of supporting voice, multimedia, and/or data transfers over a cellular network. The television also includes memory 710 for use in connection with the execution of application programming or instructions by the processor 704, and for the temporary or long-term storage of program instructions and/or data associated with notification application 106.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “television program reminder notification system”, “television program reminder system”, “reminder system”, and “system” are interchangeable and refer to the television program reminder notification system 100 of the present invention. Similarly, as used herein “program reminder notification application”, “reminder notification application”, “notification application”, and “application” are interchangeable and refer to the program reminder notification application 106 of the present invention.

Notwithstanding the foregoing, the television program reminder notification system 100 and the program reminder notification application 106 of the present invention can be of any suitable configuration as is known in the art without affecting the overall concept of the invention, provided that it accomplishes the above-stated objectives. One of ordinary skill in the art will appreciate that the configuration and specification of the components of the television program reminder notification system 100 and the program reminder notification application 106 as shown in FIGS. is for illustrative purposes only, and that many other configurations of the television program reminder notification system 100 and the program reminder notification application 106 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A television program reminder notification system comprising:
a notification server;
a program reminder notification application;
an electronic program guide (EPG) server; and
an electronic device;
wherein said notification server for sending reminders to users for a plurality of programs;
wherein said program reminder notification application setting said reminders;
wherein said EPG server having details of different programs offered to the users;
wherein said electronic device receives said reminders;
wherein said reminders having a display on said electronic device; and
further wherein said program reminder notification application activates on an operating system of a television.

2. The television program reminder notification system of claim 1, wherein said program reminder notification application displays said different programs from said EPG server for said reminders.

3. The television program reminder notification system of claim 2, wherein said program reminder notification application integrates with a channel control system of the television for automatic switching to a channel of one of said plurality of programs at said setting of said reminders.

4. The television program reminder notification system of claim 3, wherein said EPG server coupled with said electronic device over a broadcast channel.

5. The television program reminder notification system of claim 4, wherein said broadcast channel is selected from the group consisting of a satellite channel and an IP channel.

6. The television program reminder notification system of claim 5 further comprising a cloud storage for storing a user preference, a program schedule, and said reminders.

7. The television program reminder notification system of claim 6, wherein said cloud storage stores details of the users and said notification server suggests said reminders for other programs similar to those the users previously watched.

8. The television program reminder notification system of claim 7, wherein said electronic device selected from the group consisting of a television, a smartphone, and a smartwatch.

9. The television program reminder notification system of claim 8, wherein said plurality of programs are selected from the group consisting of a weekly program, a sporting event, and an Olympic event.

10. The television program reminder notification system of claim 9, wherein said reminders of said plurality of programs having an audio announcement of a show title and a start time of said plurality of programs.

11. A television program reminder notification system comprising:
a notification server;
a program reminder notification application;
an electronic program guide (EPG) server; and
an electronic device;
wherein said notification server for sending reminders to users for a plurality of programs;
wherein said program reminder notification application setting said reminders;
wherein said EPG server having details of different programs offered to the users;
wherein said electronic device receives said reminders;
wherein said reminders having a display on said electronic device;
wherein said program reminder notification application activates on an operating system of a television; and
further wherein said reminders of said plurality of programs having an audio announcement of a show title and a start time of said plurality of programs.

12. The television program reminder notification system of claim 11, wherein said program reminder notification application displays said different programs from said EPG server for said reminders.

13. The television program reminder notification system of claim 11, wherein said program reminder notification application integrates with a channel control system of the television for automatic switching to a channel of one of said plurality of programs at said setting of said reminders.

14. The television program reminder notification system of claim 11 further comprising a cloud storage for storing a user preference, a program schedule, and said reminders.

15. The television program reminder notification system of claim 14, wherein said cloud storage stores details of the users and said notification server suggests said reminders for other programs similar to those the users previously watched.

16. The television program reminder notification system of claim 11, wherein said electronic device selected from the group consisting of a television, a smartphone, and a smartwatch.

17. A method of setting a television program reminder, the method comprising the steps of:
providing a notification server, a program reminder notification application, an electronic program guide (EPG) server, and an electronic device, wherein said EPG server having details of a plurality of programs offered to the users;
activating said program reminder notification application on an operating system of a television;
setting reminders to users for said plurality of programs with said program reminder notification application;
sending reminders to users of said plurality of programs with said notification server;
receiving said reminders with said electronic device;
displaying said reminders on said electronic device; and
announcing a show title and a start time of said plurality of programs on said electronic device.

18. The method of setting a television program reminder of claim 17 further comprising a step of displaying said plurality of programs from said EPG server for said reminders.

19. The method of setting a television program reminder of claim 18, wherein said program reminder notification application integrates with a channel control system of the television for automatic switching to a channel of one of said plurality of programs at said setting of said reminders.

20. The method of setting a television program reminder of claim 19 further comprising a step of storing a user preference, a program schedule, and said reminders in a cloud storage, wherein said cloud storage stores details of the users and said notification server suggests said reminders for other programs similar to those the users previously watched.
